(19) United States
(12) Patent Application Publication
(10) Pub. No.: US 2026/0145121 A1
(43) Pub. Date: May 28, 2026

(54) COMPOSABLE DRYING UNIT FOR DRYING COMPRESSED GAS ORIGINATING FROM A COMPRESSOR

(71) Applicant: ATLAS COPCO AIRPOWER, NAAMLOZE VENNOOTSCHAP, Wilrijk (BE)

(72) Inventor: Hans HERMANS, Wilrijk (BE)

(73) Assignee: ATLAS COPCO AIRPOWER, NAAMLOZE VENNOOTSCHAP, Wilrijk (BE)

(21) Appl. No.: 19/121,990

(22) PCT Filed: Dec. 12, 2023
(86) PCT No.: PCT/IB2023/062544

§ 371 Date: Apr. 17, 2025

(30) Foreign Application Priority Data
Dec. 21, 2022 (BE) BE20226053

(51) Int. Cl. B01D 53/26; B01D 53/04

(52) U.S. Cl. CPC B01D 53/261; B01D 53/0438; B01D 53/0446; B01D 53/0454; B01D 2257/80; B01D 2259/40003; B01D 2259/4009; B01D 2259/402

(57) ABSTRACT

A module configured for composing a drying unit for drying compressed gas including an adsorption air dryer, a first connection including a first set of valves, a second connection including a second set of valves, and further including a cooling system, a heat exchanger, and an ejector. The module further includes a first set of connection points as a connection to a set of lines, in which the lines include continuous lines from the first plane to a second plane such that the second plane include a second set of connection points.

### TECHNICAL AREA

The present invention relates to a device and method for drying a compressed gas, and more specifically to a composable drying unit.

### STATE OF THE ART

Compressed gas, for example air, originating from the compressor, usually has a high moisture content. This moisture can be detrimental to the line network and undesirable in certain applications. Therefore, as is known, there is a need for a device for drying a compressed gas.

BE1027364A1 discloses a device, suitable for drying wet air from a compressor. To this end, the gas from the compressor is first heated by a heating medium, such as a heat exchanger or a heating element. Furthermore, a venturi ejector, further simply referred to as an ejector, is provided for the partial aspiration of regeneration gas, wherein the pressure drop and associated energy loss can be controlled.

A device as disclosed in BE1027364A1 is generally adapted to the flow rate that needs to be cooled and originates from the compressor. In turn, the power and associated flow rate of the compressor are adapted to the industrial application for which it is to be used.

In principle, to achieve optimal drying, from a technical and energetic point of view, a device for drying a compressed gas originating from a compressor must be tailor-made developed and assembled. In that case, the power of the device must be matched to the compressor. This also implies that all components and control technology of the device must also be tailor-made. However, it is known that this is not always possible from an economic point of view. That is why a range of different drying devices are usually provided, each with a certain capacity, whereby, based on the power of the compressor, a drying device is selected from the range that best corresponds to this power of the compressor. In other words, the power of the drying device is matched to the power of the compressor.

The method just described for selecting a drying device also implies that components and parts, such as a heating medium, adsorption dryer, and/or ejector, are constructed according to standard dimensions. In other words, for each capacity of a drying device, suitable and pre-assembled components are available to build the device. This allows to assemble a drying device in an economically efficient manner by producing the components on a large scale.

A disadvantage of this, however, is that it is not always possible to match the capacities of compressors and drying devices. For example, it may be that the power of the compressor is too high compared to the power offered by the drying devices.

A solution could be to make a drying device tailer-made, but as just described, this is disadvantageous from an economic point of view and therefore not desirable.

It is therefore an objective of the present invention to provide a composable drying device for drying a compressed gas originating from a compressor that overcomes one or more of the described disadvantages of state of the art solutions. More specifically, it is an objective of the present invention to provide a drying device the power of which can be matched in a flexible and efficient manner to the power of the compressor whose compressed gas is to be dried.

### SUMMARY OF THE INVENTION

According to the present invention, the above-identified objective is achieved by providing, according to a first aspect of the invention, a module according to claim 1, the module configured for composing a drying unit for drying compressed gas originating from a compressor, the module consisting of an adsorption air dryer comprising a first connection comprising a first set of valves, a second connection comprising a second set of valves, and further comprising a cooling system connecting to a first valve of the first set, a heat exchanger comprising a first conduit and a second conduit, an ejector comprising a main conduit running between the first conduit and the cooling system, a negative pressure conduit connecting to a second valve of the first set, the module further comprising a first set of connection points in a first plane of the module for connecting to a set of lines comprising a supply line connecting to the first conduit, a discharge line connecting to the second conduit and a first valve of the second set, a first regeneration line connecting to the second valve of the first set, a second regeneration line connecting to a second valve of the second set and the second conduit, a cooling line connecting to the first valve of the first set, CHARACTERISED IN THAT the lines comprise continuous lines from the first plane to a second plane such that the second plane comprises a second set of connection points.

The module comprises components and parts as known from a drying device according to the state of the art. These elements are a cooling system, a heat exchanger, and an ejector. Furthermore, the module further consists of an adsorption air dryer or adsorption vessel comprising a set of valves on both connections. The term “consisting of” emphasizes that the module comprises a single adsorption air dryer and that, unlike known drying devices, there are no two or more adsorption air dryers or adsorption vessels present.

The cooling system comprises a cooler and a water separator, and is connected to a valve from the set of valves connected to the adsorption air dryer. The heat exchanger of the module comprises two conduits, through each of which a fluid can be passed for exchanging heat between the two fluids through the different conduits. The heat exchanger can be of the tube heat exchanger, plate heat exchanger, or any other type, and can operate according to the counter-current principle or flow in the same direction. It should therefore be understood that the type and operation of the heat exchanger do not form an essential part of the disclosed invention.

The module further comprises an ejector with a main conduit and a negative pressure conduit. By allowing the fluid to flow through the main conduit, a negative pressure will be created in the negative pressure conduit and a fluid present in it, or present in a line connected to this negative pressure conduit, will then be aspirated by the created negative pressure.

The main conduit of the ejector runs between a conduit of the heat exchanger and the cooling system. The negative pressure conduit is further connected to a valve that is connected to a connection of the adsorption air dryer.

The module further comprises a set of connection points, each of which serves as a connection to a set of lines within the module. This set of lines comprises a supply line, a discharge line, a first regeneration line, a second regeneration line, and a cooling line.

The supply line in the module is connected to the heat exchanger conduit to which the ejector is also connected. In other words, along the supply line, a fluid can flow through the conduit of the heat exchanger and then to the ejector.

The discharge line connects to the other conduit of the heat exchanger, i.e. the conduit that does not run between the supply line and the ejector. The discharge line is also connected to a valve that is connected to the adsorption dryer, at a connection different from the connection to which the cooling system and the negative pressure conduit of the ejector are connected.

The first regeneration line connects to a valve connected to the adsorption dryer and to the same connection of the adsorption dryer as the valve connected to the cooling system. Two valves are therefore connected to this connection, which is different from that of the discharge line, a valve for the cooling system and a valve for the first regeneration line. The negative pressure conduit of the ejector is also connected to this last valve.

The second regeneration line connects to the conduit of the heat exchanger to which the discharge line is also connected. This means that this conduit of the heat exchanger runs between the discharge line and the second regeneration line. The second regeneration line is further connected to the second valve at the connection of the adsorption dryer to which the discharge line is also connected.

Finally, the cooling line is connected to the valve to which the cooling system is also connected.

As already mentioned, connection points are provided for these five lines to which connections can be made. These connections are used to connect external lines to the lines in the module as just described.

According to an innovative and new concept, the module further comprises a second set of connection points that connect to the same lines. This second set of connection points have the same function as the first set of connection points, i.e. for connecting external lines to the lines in the module. This means that the lines are continuous lines between the sets of connection points. In other words, the supply line runs between a first connection point in the first plane and a first connection point in the second plane, the discharge line runs between a second connection point in the first plane and a second connection point in the second plane, the first regeneration line runs between a third connection point in the first plane and a third connection point in the second plane, the second regeneration line runs between a fourth connection point in the first plane and a fourth connection point in the second plane, and the cooling line runs between a fifth connection point in the first plane and a fifth connection point in the second plane.

Furthermore, note that the connection points can also lie in the same plane, such that, in the above illustration, the first and second planes are the same.

The lines are continuous lines between the respective connection points as just described. The lines run between the first plane and the second plane, whereby the shape, the path and/or the trajectory the lines in the module are following is in principle not a limiting feature of the module. In other words, the fact that the module has connection points for the same lines in two different or the same planes offers some advantages compared to known drying devices from the state of the art.

Such a configuration of a module with two sets of connection points allows to link two modules together. By linking two modules, it allows to compose a full-fledged drying device that comprises two adsorption dryers, as known in the state of the art, wherein a first adsorption dryer can be used to dry gas, while the other adsorption dryer can be regenerated. The latter is possible due to the existing regeneration lines, as will be explained further.

The connection points also comprise means for connecting external lines, for example those originating from a compressor, and/or between the connection points themselves, hence with another module.

Because each module has two sets of connection points, it is not only possible to link two modules together, but also more than two modules. Therefore, if a high power and/or flow rate is required, it is not necessary to adapt the components or elements of a drying device by upscaling them, but to link several modules together until the desired power and/or flow rate is achieved.

Another advantage of this modular construction is that, in addition to the flexibility for constructing drying devices with a large capacity and/or flow rate, it is less restrictive in terms of transport and ease of handling. Therefore, a drying device with a large capacity does not have to be moved in its entirety from the production hall where the drying device is assembled, to the industrial site where the drying device is to be used, but it can be transported per module and assembled on-site via the connection points. Since a module is, by definition, smaller than the complete drying device consisting of these modules, a single module is also easier and safer to handle and to move. Furthermore, a module is also easier to assemble, components of it can be placed multiple times, which leads to higher quantities and is therefore more cost-efficient, and a single module can also be replaced more easily if necessary.

According to an embodiment, a module can therefore also comprise a base plate, wherein the base plate is suitable for being transported using to regular transport. Regular transport should further be understood to mean regular transport for, for example, a public road, a business site, and/or a business hall, where certain restrictions and safety conditions apply, such as permitted speed, permitted dimensions, and/or maximum weight.

According to an embodiment, the first and second set of connection points are arranged mirror-symmetrically with respect to each other. This means that the connection points in both the first and second planes are at the same height, direction, and location from the point of view of a certain position relative to the first or second plane, and that preferably the first plane is opposite the second plane. In other words, there is an imaginary plane that is parallel and in the middle between the first and second plane, and which is therefore a plane of symmetry for the connection points. Note that, in principle, mirror-symmetry does not apply to the lines themselves.

However, preferably the lines according to an embodiment are straight lines between the connection points of both planes. This means that both the connection points and lines are mirror-symmetrical. However, it should be noted that this mirror-symmetry does not apply to branches to the various components and parts in the module as previously clarified.

The advantage of mirror-symmetry is that different modules fit together correctly and closely. In other words, a second plane of a first module can easily be placed against a first plane of a second module because the height and position of the connection points correspond to each other. The connection can then be made without the need for intermediate pieces or intermediate connections. The linkage can then be made at connection points in the first plane of the first module, such as to the compressors and discharge, and the other connection points in both the first plane of the first module and in the second plane of the second module can then be connected to the side where there is no linkage. According to an embodiment, the first and/or second set of connection points can also comprise one or more closing means for closing the respective connection point. These closing means can be, for example, flanges, valves, or stops, or any other closing means suitable for closing compressed air lines.

According to an embodiment, the module can further optionally comprise a second water separator that connects to the second valve of the first set. This water separator is then placed between the negative pressure conduit and a valve on the first connection of the adsorption dryer. This allows water or condensate, flowing through the negative pressure conduit, to be drained.

According to a preferred embodiment, the module further comprises a bypass valve running between the supply line and the ejector after the main conduit. In other words, the bypass valve, also called a bypass valve in English, connects the supply line directly to the main conduit of the ejector on the cooling system side. This allows the heat exchanger, as well as the negative pressure conduit of the ejector, to be bridged, such that no compressed gas will flow through. This allows the overall pressure drop across the module to be reduced. This is advantageous when, for example, the adsorption dryer is oversized. Moreover, when the drying unit goes into standby, no regeneration or cooling is required. The bypass valve will also open when the module is switched between adsorption and regeneration and vice versa. With a modular construction, a bypass valve will not be opened separately, but it is always each valve of each module that is opened.

The module can further comprise a heating module that is connected between the second regeneration line and the second conduit of the heat exchanger. This heating module will heat the compressed gas before heat is exchanged via the heat exchanger. This heating module is necessary when the inlet temperature is insufficient.

The module may also comprise a control unit, configured to control the valves and, if present, the bypass valve. When multiple modules are linked to each other, the control unit can communicate with a control unit of a linked module. This allows, for example, a first module to be controlled in a drying function and simultaneously the second linked module in a regeneration function. It is also possible to link more than two modules, as will be explained further.

In order to link different modules with each other from a control technical point of view, the connection points can also comprise a connection point for the control unit.

In order to optimally control the module, it will preferably also comprise a measuring module for determining the regeneration status of the module, and more specifically of the adsorption dryer. This measuring module can, for example, comprise a dew point meter, but preferably consists of a pressure meter, a temperature sensor and a pressure difference meter. The regeneration status can be determined based on these last three sensors and has the advantage that this is cheaper than a dew point meter. The adsorption time can also be derived from this. The measuring module can also be configured to determine an adsorption status and/or cooling status of the module.

The measuring module can then further communicate with the control module for optimal control of different modules when linked together to form a drying unit. Furthermore, it is also possible to control everything with a single control unit.

A second aspect of the invention comprises a module, configured for composing a drying unit for drying compressed gas originating from a compressor, the module consisting of an adsorption air dryer comprising a first connection comprising a first set of valves; a second connection comprising a second set of valves; and further comprising a cooling system connecting to a first valve of the first set; a heat exchanger comprising a first conduit and a second conduit; an ejector comprising a main conduit running between the first conduit and the cooling system; a negative pressure conduit connecting to a second valve of the first set; the module further comprising a first set of connection points for connection to a set of lines comprising a supply line connecting to the first conduit; a discharge line connecting to the second conduit and a first valve of the second set; a first regeneration line connecting to the second valve of the first set; a second regeneration line connecting to a second valve of the second set and the second conduit; a cooling line connecting to the first valve of the first set; wherein the connection points are positioned in the same plane of the module.

This module can also comprise all the technical features of a module according to the first aspect, such as a cooling system with a cooler and a first water separator, a second water separator connecting to the second valve of the first set, a bypass valve running between the supply line and the ejector after the main conduit, a heating module connected between the second regeneration line and the second conduit configured to heat the compressed gas, a control unit configured to control the first and/or second set of valves and/or the bypass valve if present, a measuring module configured to determine a regeneration status, adsorption status, and/or cooling status, and a base plate for mounting the module.

According to an embodiment of the module according to the second aspect, the connection points in the plane are further positioned such that they coincide with connection points of a module according to the first aspect in the first and second planes, respectively, when placed with the plane against the first and second planes, respectively, of the first module according to the first aspect of the invention.

The modules according to the second aspect of the invention are therefore intended to be placed at the ends of a series of linked modules for composing a drying unit according to a third aspect of the invention.

The third aspect of the invention therefore comprises a drying unit for drying compressed gas originating from a compressor comprising two or more modules according to the first and/or second aspect of the invention, the two or more modules connecting to each other via respective corresponding lines.

According to a fourth aspect, a compressor installation, comprising a compressor with an outlet connected to a supply line of one of the modules of the drying unit according to the second aspect is disclosed.

### BRIEF DESCRIPTION OF THE DRAWINGS

The invention will be further illustrated with reference to the figures, wherein

FIG. 1 illustrates a drying unit for drying compressed gas originating from a compressor as known in the state of the art; and

FIG. 2 schematically illustrates a time course of the regeneration, adsorption and cooling phases as completed in the drying unit of FIG. 1; and

FIG. 3 illustrates an extension of the drying unit of FIG. 1;

FIG. 4 illustrates a module for composing a drying unit for drying compressed gas originating from a compressor according to an embodiment of the invention;

FIG. 5 illustrates a drying unit composed with modules as in FIG. 4; and

FIG. 6 illustrates a drying unit composed with three modules.

### Detailed Description of the Embodiments

The present invention will be described with respect to certain embodiments and with reference to certain drawings, but the invention is not limited thereto and is determined only by the claims. The drawings described are only schematic and non-limiting. In the drawings, the size of certain elements may be exaggerated and not drawn to scale for illustrative purposes. The dimensions and relative dimensions do not necessarily correspond to actual practical embodiments of the invention.

Furthermore, the terms first, second, third and the like are used in the description and in the claims to distinguish between similar elements and not necessarily to describe a sequential or chronological order. The terms are interchangeable under appropriate circumstances and the embodiments of the invention may be practiced in sequences other than those described or illustrated herein.

In addition, the terms above, below, over, below and the like in the description and claims are used for illustrative purposes and not necessarily to describe relative positions. The terms so used are interchangeable under appropriate circumstances and the embodiments of the invention described herein may be employed in orientations other than those described or illustrated herein.

Furthermore, the various embodiments, although referred to as “preferred embodiments”, are to be construed as exemplary means of carrying out the invention rather than as a limitation on the scope of the invention.

The term “comprising”, used in the claims, should not be construed as being limited to the means or steps set forth thereafter; the term does not exclude other elements or steps. The term should be interpreted as specifying the presence of the mentioned features, elements, steps or components referred to, but does not exclude the presence or addition of one or more other features, elements, steps or components, or groups thereof. The scope of the expression “a device comprising means A and B” should therefore not be limited to devices consisting only of components A and B. The meaning is that, with respect to the present invention, only components A and B of the device are listed, and the claim is further construed to also include equivalents of these components.

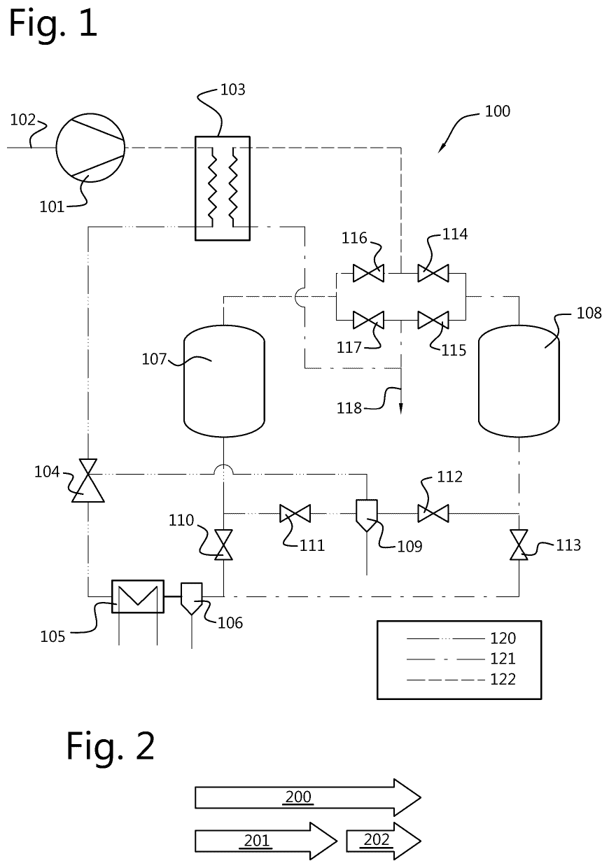

FIG. 1 illustrates a drying unit 100 for drying compressed gas originating from a compressor 101 as known in the state of the art. Supply gas 102 is compressed by the compressor 101 and then dried by the drying unit 100, as is further illustrated.

The drying unit 100 comprises two adsorption dryers 107, 108 and a set of valves 110-117 to allow the gas to flow into the drying unit 100 in a desired direction. Furthermore, the drying unit 100 comprises a heat exchanger 103 of the air-air type, an ejector 104, a water cooler 105, two water separators 106 and 109 and a discharge 118.

When supplied, the compressed gas will exchange heat with a portion of already dried gas via the heat exchanger 103, as a result of which the gas has already been partially cooled before it flows into the main conduit of the ejector 104. The ejector 104 has a negative pressure conduit that is further connected to water separator 109, which in turn is connected to valves 111 and 112. The main conduit of the ejector 104 is further connected to the water cooler 105, which is further connected to the water separator 106 and is further connected to valves 110 and 113. Valves 110 and 113 are connected to the adsorption dryer 107 and 108 respectively, just like valves 111 and 112, which are connected to the same side of these respective adsorption dryers 107 and 108.

On the other side of the adsorption dryers 107 and 108, there are the connected valves 116 and 117 and valves 114 and 115, respectively. Between the valves 114 and 116 and valves 115 and 117, respectively, there is a connection to the heat exchanger 103. Finally, a discharge 118 is provided between valves 115 and 117 and a connection to the heat exchanger 103.

By changing the position of the valves 110-117, being either open or closed according to a predetermined pattern, the operation of the adsorption dryers 107 and 108 can be changed to either drying the compressed gas or regenerating any desiccant present in a respective adsorption dryer 107 and 108. A desiccant is a regenerable drying agent intended to adsorb moisture from the compressed gas by means of adsorption and which, when saturated with moisture, can be dried by passing a so-called regeneration gas through it. This regeneration gas is typically a warm gas.

FIG. 1 further illustrates which path the compressed gas follows when the desiccant in the adsorption dryer 107 is generated and the compressed gas in adsorption dryer 108 is dried by adsorption. For this purpose, valves 110, 114, 112, and 117 are closed, and valves 111, 113, 115, and 116 are open. The dotted line 122 then represents the regeneration cycle, and the line 121 with a dashed mark represents the adsorption cycle. This path 121 is followed by the gas when gas flows in the main conduit of the ejector 104 and a vacuum is thereby created in the underpressure conduit, such that gas is aspirated along the path just described and by a correct position of the valves 114-117.

In a practical embodiment, the ejector 104 is a controllable ejector, configured such that the flow rate flowing through it, can be controlled. This also allows to regulate how much flow can be aspirated via the aspiration line due to the vacuum that is created. The flow rate can then be adjusted to the time required to regenerate the adsorption vessel 107, and more specifically the desiccant contained therein.

With reference to FIG. 2, one then has a time course of the regeneration, adsorption and cooling phases that are completed in the drying unit 100, hence a drying unit composed of two modules. Reference 200 represents the time of a complete adsorption phase, for example for adsorption vessel 108, and wherein reference 201 illustrates the time required to regenerate the adsorption vessel 107. The remaining time 202 during which the adsorption vessel 107 has been generated, but during which adsorption vessel 108 is still used for drying the gas, can be used to carry out an additional cooling phase in which a cooling gas flows through the adsorption vessel 107. This is further illustrated by line 120 with a dashed mark by means of three dots. This line 120 illustrates the cooling cycle in which the compressed gas is cooled successively by the heat exchanger 103 and the portion flowing through the main conduit of the ejector 104 by water cooler 105. Furthermore, this line 120 also illustrates the diverted portion of the compressed gas to the negative pressure conduit. Note that, if the drying unit is composed of more than two modules, the time course will be different.

Line 122 runs from the top of the heat exchanger 103 to valve 116 and to the top of the adsorption dryer 107. The line 121 runs from the bottom of the heat exchanger 103 to the discharge 118 to the valve 115 through the adsorption dryer 108 to valve 113 and to water separator 106. Line 122 runs from the bottom of the heat exchanger 103 to the ejector 104 and to the water cooler 105, and from the negative pressure conduit of the ejector 104, to the water separator 109, to the valve 111, and to the bottom of the adsorption dryer 107.

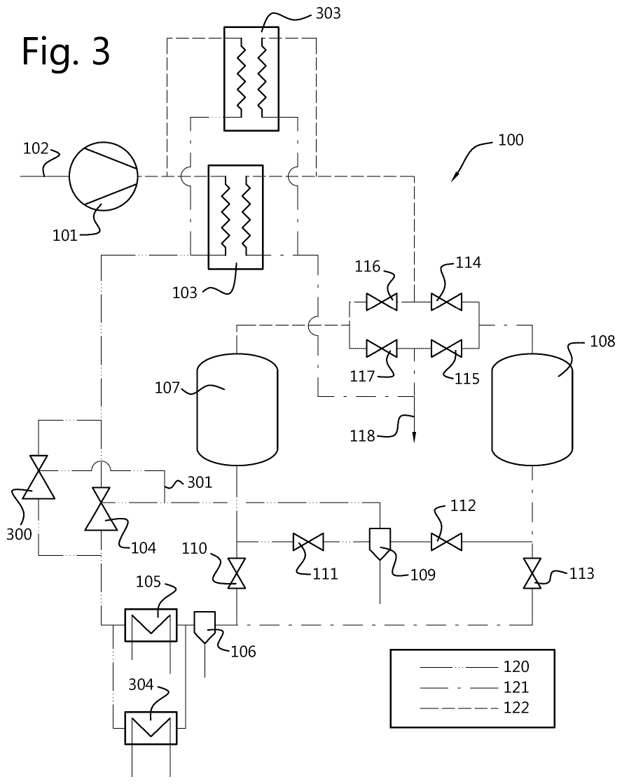

In order to expand this drying device 100 as known in the state of the art in such a way that it is suitable for a higher flow rate of compressed gas, certain elements or parts can be expanded as illustrated in FIG. 3. This provides the same drying device 100 with the same components as illustrated in FIG. 1, but wherein heat exchanger 103 is expanded by providing an additional heat exchanger 303 parallel to the first heat exchanger 103. Furthermore, an additional ejector 300 is connected in parallel to the ejector 104, and a second water cooler 304 is connected in parallel to the water cooler 105.

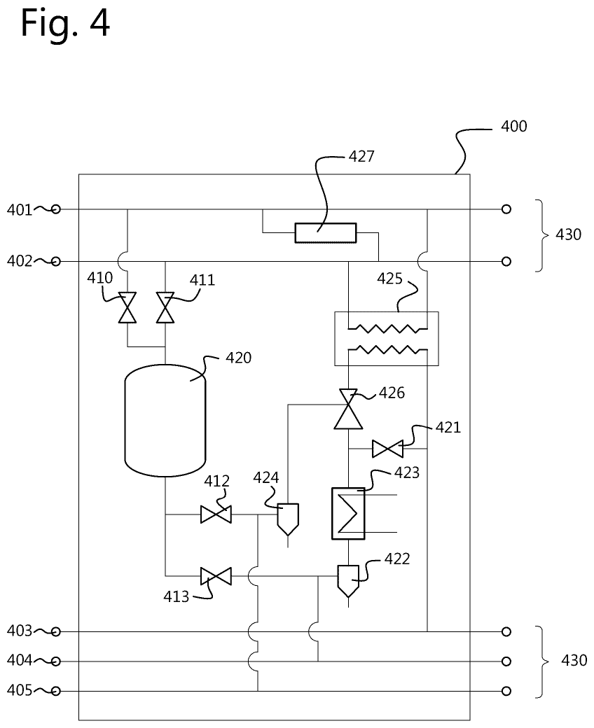

Another possibility than duplicating components is to provide, according to the innovative aspect of the invention, modules configured for composing a drying unit such as those in FIG. 1 and FIG. 3. Such a module is illustrated in FIG. 4.

The module 400 comprises a set of valves 410-413 connected to an adsorption vessel 420, two water separators 422 and 424, a water cooler 423, a heat exchanger 425, and an ejector 426. Optionally and preferably, the module can comprise a bypass valve 421, and a heating module 427.

Furthermore, there is a supply line, a discharge line, a first regeneration line, a second regeneration line, and a cooling line. The supply line has connection point 403 as its first connection point, the discharge line has connection point 402 as its first connection point, the first regeneration line has connection point 405 as its first connection point, the second regeneration connection has connection point 401 as its first connection point, and the cooling line has connection point 401 as its first connection point 404.

Furthermore, these lines each have a second connection point, illustrated by connections 430.

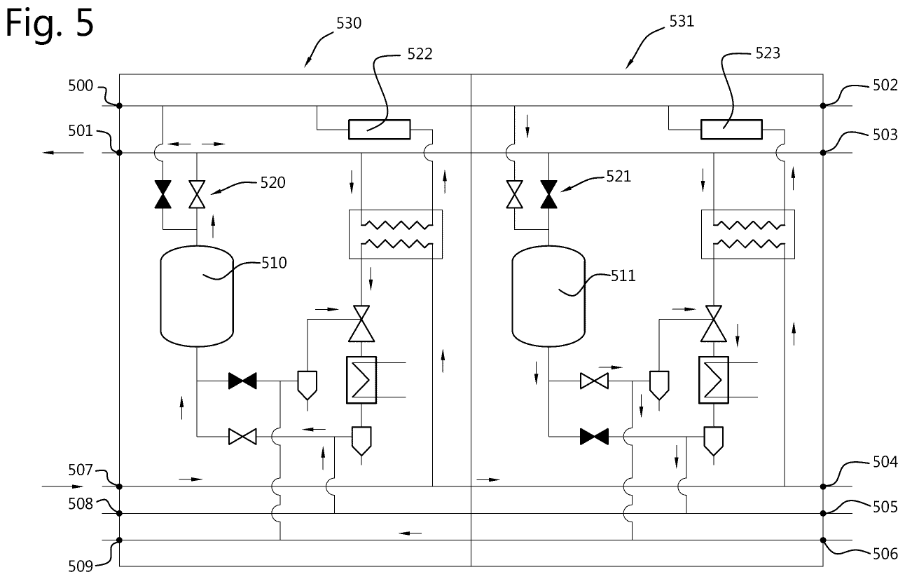

By having both a first and a second connection per line, different modules can be linked together, as illustrated in FIG. 5.

With reference to FIG. 5, a first module 530 can then be set such that its adsorption vessel 510 is in an adsorption mode, while for a second module 531, directly connected to this first module 530, its adsorption vessel 511 is set in a regeneration mode.

Furthermore, both module 530 and module 523 have an optional heating element 522 and 523, respectively.

To achieve a correct connection between both modules 530 and 531, connection points 500, 502, 503, 504, 505, 506, 508, and 509 must be closed, and connection point 507 becomes the input of the composite module 530-531 and connection point 501 becomes the discharge 530-531 thereof.

Furthermore, the whole of the valves must be adjusted to allow the compressed gas in the composite module 530-531 to flow in a correct direction. The positions of the valves are further illustrated, on the one hand, by a valve with a fully filled black surface, and on the other hand, by a valve with an empty white surface. A valve with a fully filled surface illustrates a closed valve, while a valve with a blank white surface illustrates an open valve. For example, valve 520 in module 530 is an open valve, while valve 521 in module 531 illustrates a closed valve.

Finally, the arrows in FIG. 5 illustrate the path that the compressed gas will take to be dried via inlet 507 to outlet 501, with the adsorption vessel 510 in adsorption mode and the adsorption vessel 511 in regeneration mode.

The composed module 530-531 can then provide the same function as the module 400 illustrated in FIG. 4 without having to duplicate the various components as explained, but by linking two individual modules 530-531.

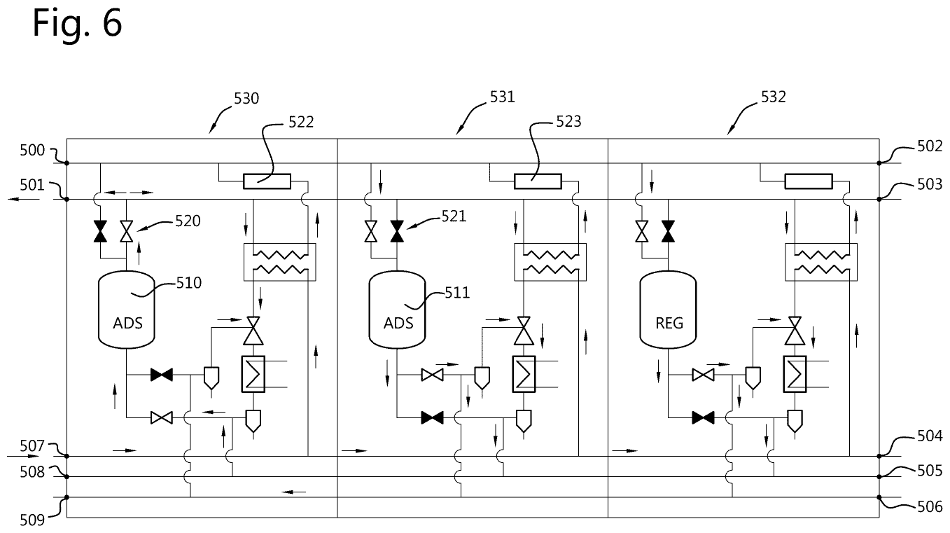

Finally, FIG. 6 illustrates an arrangement in which three modules 530, 531, and 532 are linked together to form a drying unit. The composed modules 530-532 correspond to the modules as illustrated in FIG. 5, wherein an extension is made with module 532. This allows the power of the drying unit to be further increased and thus adapted to the customer's needs.

1-16. (canceled)

17. A module configured for composing a drying unit for drying compressed gas originating from a compressor, the module consisting of:
an adsorption air dryer comprising:
a first connection comprising a first set of valves;
a second connection comprising a second set of valves; and further comprising:
a cooling system connecting to a first valve of the first set;
a heat exchanger comprising a first conduit and a second conduit;
an ejector comprising:
a main conduit running between the first conduit and the cooling system;
a negative pressure conduit connecting to a second valve of the first set; the module further comprising a first set of connection points in a first plane of the module for connection to a set of lines comprising:
a supply line connecting to the first conduit;
a discharge line connecting to the second conduit and a first valve of the second set;
a first regeneration line connecting to the second valve of the first set;
a second regeneration line connecting to a second valve of the second set and the second conduit;
a cooling line connecting to the first valve of the first set; wherein
the lines comprise continuous lines from the first plane to a second plane such that the second plane comprises a second set of connection points, wherein the first and second set of connection points are arranged mirror-symmetrically with respect to each other.

18. The module according to claim 17, wherein the lines comprise straight lines between the first and the second plane.

19. The module according to claim 17, wherein the first and/or second set of connection points further comprise one or more closing means configured for closing one or more of the one or more multiple lines.

20. The module according to claim 17, wherein the cooling system comprises a cooler and a first water separator.

21. The module according to claim 17, further comprising a second water separator connecting to the second valve of the first set.

22. The module according to claim 17, further comprising a bypass valve running between the supply line and the ejector after the main conduit.

23. The module according to claim 17, further comprising a heating module connected between the second regeneration line and the second conduit, the heating module being configured to heat the compressed gas.

24. The module according to claim 17, further comprising a control unit configured to control the first and/or second set of valves, and/or the bypass valve when present.

25. The module according to claim 24, wherein the first and/or second set of connection points further comprises a connection point connected to the control unit.

26. The module according to claim 17, further comprising a measuring module configured to determine a regeneration status, adsorption status, and/or cooling status of the module.

27. The module according to claim 17, further comprising a base plate for mounting it, the base plate being suitable for being transported by regular transport.

28. A drying unit for drying compressed gas originating from a compressor, comprising two or more modules according to claim 17, wherein the two or more modules connect to each other via respective corresponding lines.

29. A compressor installation comprising a compressor with an outlet connected to a supply line of one of the modules of the drying unit according to claim 28.
